(19) United States
(12) Patent Application Publication
(10) Pub. No.: US 2012/0296508 A1
(43) Pub. Date: Nov. 22, 2012

(54) ELECTRIC PROPULSION SYSTEM FOR VEHICLES

(76) Inventor: Samuele Mazzini, Montone (IT)

(21) Appl. No.: 13/520,104

(22) PCT Filed: Dec. 29, 2010
(86) PCT No.: PCT/IT10/00518

§ 371 Date: Aug. 3, 2012

(30) Foreign Application Priority Data
Dec. 30, 2009 (IT) RN2009A000062

(51) Int. Cl. B60L 11/18; B60K 1/00

(52) U.S. Cl. 701/22; 74/640

(57) ABSTRACT

A propulsion system (1) for a self-propelled vehicle comprises, in combination, an electric motor (2) powered by electric batteries (14) transported on the vehicle and equipped with a driving shaft (3); a clutch coupling (4), connected to the driving shaft (3) of the electric motor (2); a gearbox (5) connected to the clutch coupling (4); and a mechanical transmission (6) operatively interposed between the gearbox (5) and at least one driving wheel (7) of the self-propelled vehicle.

### TECHNICAL FIELD

This invention relates to a propulsion system for a self-propelled vehicle, able to move because it is driven by an electric motor powered by storage batteries transported by the vehicle.

### BACKGROUND ART

In the propulsion systems of vehicles which use internal combustion engines, it is known that the mechanical feature, that is to say, the curve of the torque supplied by the engine with changes in the number of revolutions, is not directly usable at the wheels because: the engine is unable to start under a load; the engine supplies a torque with reduced intensity at a high number of revolutions; and the torque travel in the range of use is normally too small relative to the extensive variations in external load caused by the resistance to motion encountered by the vehicle.

Therefore, the vehicle must be fitted with a device which is able to transmit to the wheels the power factors (torque and number of revolutions in the unit of time) of the engine, suitably modified according to the various requirements. As it is known, this device is the transmission which, in an extremely simplified form comprises: a clutch coupling, which makes the engine independent of the wheels and which once the engine has started with no load, allows the gradual addition of the external load; a fixed ratio (rear-axle ratio, or equivalent) which, by reducing the engine revolutions, causes a proportional increase in its torque, and a set of variable ratios—with shifts or continuous—(gearbox or speed variator) which are designed to adjust the driving torque to the variations in the external load encountered by the vehicle.

If, in contrast, the vehicle is driven using electric motors, the transmissions to be used have a much simpler structure than that of internal combustion engines. As it is well known, electric motors are free of problems related to stalling or the like. Electric motors, being able to start from zero speed up to the maximum speed (obviously, according to a predetermined acceleration ramp), in general do not need transmissions which include the presence of a clutch coupling operatively positioned between the driving shaft and the transmission.

A particular embodiment of such types of propulsion systems is, moreover, described and illustrated in document U.S. Pat. No. 5,552,988. In that solution a continuous speed variator is used which is positioned immediately downstream of the driving shall, to which it is permanently and irremovably connected. Downstream, the continuous variator in turn connects to an automatic slipping clutch coupling. Downstream of the clutch coupling there is also gearing with a fixed gear ratio, which transmits the driving power to the driving wheel.

In that type of vehicle the variator modulates the continuous gear ratio in a way automatically controlled by inertial masses which, operated by centrifugal force, move along suitable tracks made on a bell of a variator input pulley. Moreover, as regards the clutch coupling, the interruption of the transmission of motion to the driving wheel is automatically controlled by the transition by a “single” established threshold value from a suitable preset calibration value.

In the solution described above the automated devices for the speed change and clutch coupling slipping prevent the vehicle driver from having the possibility of modulating as desired the driving technique with relation to the conditions of resistance to travel effectively encountered by the vehicle.

The construction layout referring to the various types of electric motors indicated above therefore has the clear advantage of greatly simplifying the construction of propulsion systems. However, it is also affected by significant disadvantages also of prime importance which until now limited development of its application.

A first disadvantage is the fact that vehicle propulsion using an electric motor will struggle to allow optimum adjustment of the driving torque to the most diverse external load conditions encountered by the vehicle during travel: for example significant changes in road gradient.

Although electric motors can guarantee a large driving torque and, therefore, high acceleration, with power being favoured at the sizing design stage, the advantage of requiring a simpler transmission than those used with internal combustion engines is offset by reaching rather low speeds. Vice versa, when operating in such a way as to obtain a good speed, this is inevitably accompanied by a poor capacity for acceleration and, therefore, poor driving wheel fraction.

Another disadvantage is the fact that the driving sensation in a vehicle equipped with an electric motor is very different to that of a vehicle driven by an internal combustion engine. In practice, driving an electrically-driven self-propelled vehicle consists of a simple ON/OFF command, which does not allow the vehicle driver to play any significant role in the discretionary control of the vehicle with relation to the external load conditions actually encountered on each occasion.

The reasons indicated above have resulted in a prejudice, which has become consolidated over time, according to which—with the exception of vehicles which travel on rails, or which move on smooth and horizontal surfaces—the use of electric drive units (for example, in road or off-road vehicles) is considered unsuitable for providing satisfactory performance, thus being relegated to areas of use concerning toys, amateur applications and, at best, a reserve, backup role, for much more important primary drive units consisting of internal combustion engines.

### DISCLOSURE OF THE INVENTION

The main aim of this invention is therefore to provide a propulsion system for a self-propelled vehicle, within the scope of an electric drive unit, which allows the vehicle driver to find the right compromise between motor torque and speed in all real driving situations.

Another aim of the invention is to allow driving of a self-propelled vehicle which is electrically driven, which the driver can drive using the same driving techniques used to drive vehicles driven by conventional internal combustion engines, the only differences being due to the fact that the motor does not have exhaust emissions and the vehicle driver does not perceive any operating noise.

The technical features of this invention, in accordance with the above aims, are clear from the content of the claims herein, in particular claim 1, and from any of the claims directly or indirectly dependent on claim 1.

### BRIEF DESCRIPTION OF THE DRAWINGS

The advantages of this invention are more apparent in the detailed description which follows, with reference to the accompanying drawings which illustrate preferred, non-limiting embodiments of the invention, in which:

FIG. 1 is a schematic diagram of a propulsion system according to the invention;

FIG. 2 is a three-dimensional exploded view of a propulsion system according to the invention, with some parts cut away to better illustrate others, and seen from a first observation side;

FIG. 3 is a view of the system of FIG. 2 seen from the opposite side to that of FIG. 2;

FIG. 4 is a perspective view of a handlebar for driving a vehicle equipped with a propulsion system according to the invention;

FIG. 5 is an assembly view, in cross-section, of the propulsion system according to the previous figures.

### DETAILED DESCRIPTION OF THE PREFERRED EMBODIMENTS OF THE INVENTION

With reference to the accompanying drawings, the numeral 1 denotes in its entirety a propulsion system for a self-propelled vehicle, identifiable for example as a motorcycle for off-road use. The reference to that particular type of self-propelled vehicle is significant due to the fact that an off-road motorcycle for sports use embodies a type of application in which power, speed, reliability and autonomy are essential. Moreover, the spaces available are limited and weights must be within rather restrictive parameters to allow correct drivability.

However, what is said relative to that particular type of application shall be understood to be by way of example only and non-limiting, since the system according to this description may also advantageously be used when applied to many other types of different self-propelled vehicles.

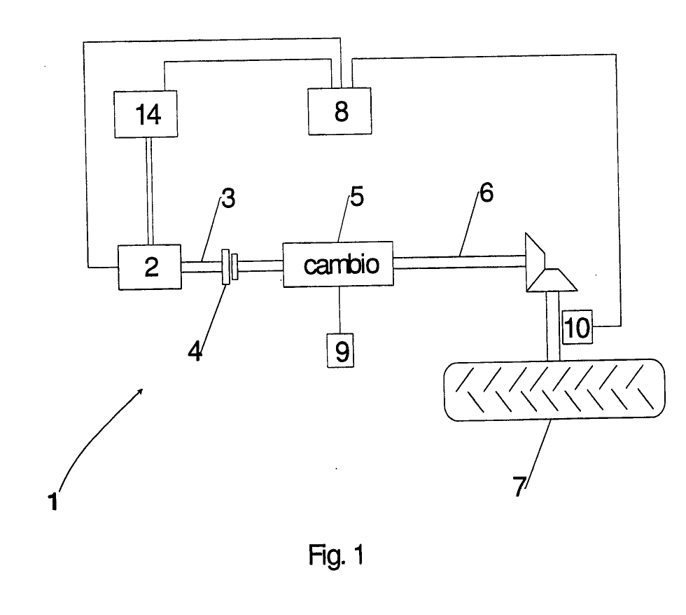

FIG. 1 shows that the propulsion system 1 basically comprises, in combination, an electric motor 2 powered by electric batteries 14 transported by the vehicle, and equipped with a driving shaft 3; a clutch coupling 4, connected directly to the driving shaft 3 of the electric motor 2; a gearbox 5 positioned downstream of the clutch coupling 4; and a mechanical transmission 6 operatively interposed between the gearbox 5 and at least one driving wheel 7 of the self-propelled vehicle.

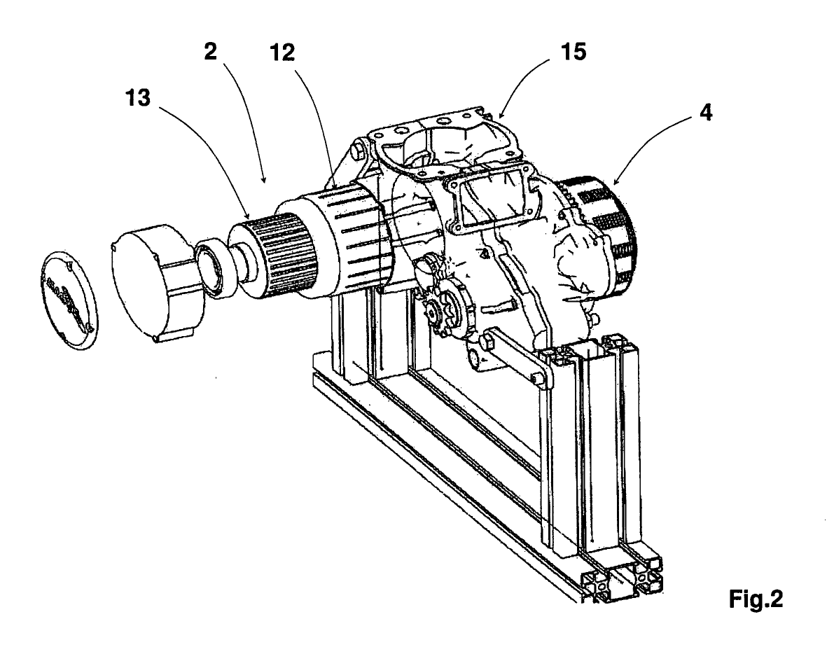

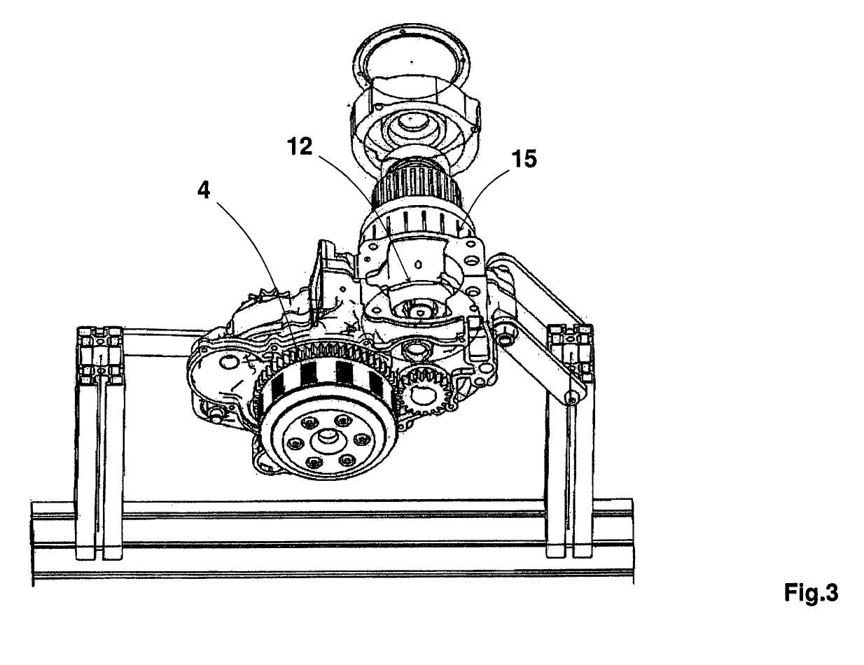

More particularly, the electric motor 2 is a brushless motor with multi-pole ring, comprising (FIGS. 2, 3 and 5) an electric stator 12 and a rotor 13 which are housed in a motor body labelled 15.

The motor body 15 may be considered ideally in the form of the engine body 15 of an engine for a conventional motorcycle, with complete removal of the internal combustion unit, substituting it with the electric motor 2 which is mounted in the motor body 15 in such a way that it is coaxial with the axis of rotation of the original driving shaft of the internal combustion engine.

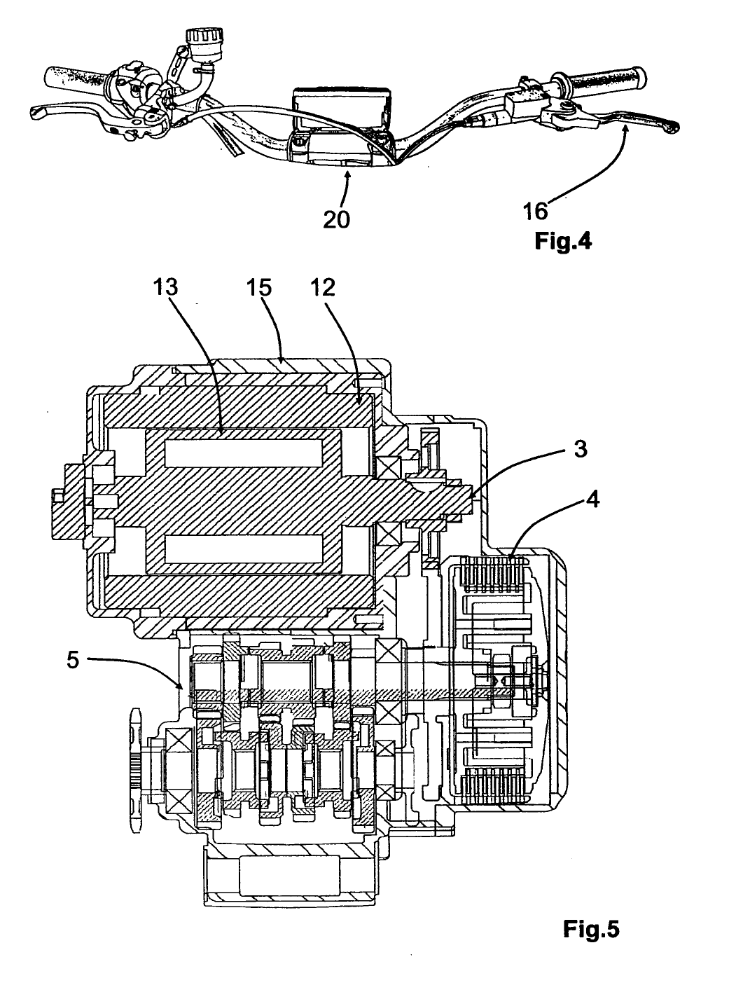

The clutch coupling 4, the gearbox 5 and the mechanical transmission 6 interposed between the gearbox 5 and the driving wheel 7 are of completely conventional construction. The clutch coupling 4 is not strictly necessary, since the electric motor 2 is able to start from zero speed and to reach a maximum speed by following a preset acceleration ramp. However, the presence of the clutch coupling 4 allows a guarantee of a driving technique similar to that used with a conventional internal combustion engine in which the speed change between one gear and another (that is to say, the speed change with discontinuous variation of the gear ratio) may occur with the necessary smoothness, regulated by the driver's use of manual and deliberate control of the clutch coupling 4 in consequence of using a control lever 16 located on a handlebar 20 for driving the self-propelled vehicle (FIG. 4). In the propulsion system 1 according to the invention, the torque generated by the motor 2 is very high. It is easy to reach peak values in “Nm” which are higher than the values that can be reached by conventional internal combustion engines.

The system 1 comprises operating and control means 8, which are operatively interposed between the batteries 14 and the electric motor 2 in such a way as to manage the power input into the batteries 14 in a range of voltages between the limits 48 to 96V and with a range of motor output power of 48 to 90V.

These operating and control means 8 can be programmed using a relative software in such a way as to set the acceleration, deceleration and braking ramps of the self-propelled vehicle, allowing the simulation even of operation of engine braking just like that generated by a real conventional internal combustion engine.

The operating and control means 8 can also be programmed using relative software in such a way as to translate graphs of internal combustion engine use detected at the test bench, with the electric motor 2 thus simulating operation of the reference internal combustion engine, detected in experimental conditions, emulating its specific operating features.

The system 1 preferably comprises, on the gearbox 5, sensor means 9 for mapping different acceleration and deceleration ramps, depending on the vehicle gear selected. Advantageously, this allows operating conditions which allow the best possible modulation of the performance of the self-propelled vehicle and limiting, for example, of the operating currents which would make management of the vehicle in low gears difficult.

The system 1 may advantageously comprise accelerometer means 10, operatively interconnected with the operating and control means 8, for regulating the energy supplied by the electric motor 2, the regulation being correlated with traction actions of predetermined intensity exchanged between the driving wheel 7 and the ground.

In that way, it is possible to discharge the traction dynamic control power when conditions occur in which the driving wheel slips 7 relative to the ground, that is to say, when the motor 2 supplies a quantity of energy greater than that which the driving wheel 7 is able to usefully transfer to the ground without slipping.

The control system 1 also allows the possibility of managing the recovery of energy generated by the electric motor 2 during drifting and inertial deceleration of the self-propelled vehicle. This may be achieved by activating an exchange circuit controlled by the operating and control means 8 and designed to automatically recharge the batteries 14 of the self-propelled vehicle when the energy produced by the electric motor 2 is in excess of the energy required to drive the self-propelled vehicle.

The invention described above is susceptible of industrial application and may be modified and adapted in several ways without thereby departing from the scope of the inventive concept. Moreover, all details of the invention may be substituted by technically equivalent elements.

1. A propulsion system for a self-propelled vehicle, characterised in that it comprises, in combination, an electric motor (2) powered by electric batteries (14) transported on the vehicle and equipped with a driving shaft (3); a gearbox (5) with stepped, discontinuous variable gear ratios; a clutch coupling (4), interposed between the driving shaft (3) of the electric motor (2) and the gearbox (5); the gearbox (5) allowing a speed change between one gear and another in consequence of using a clutch lever (16) controlled by the driver of the self-propelled vehicle; the system (1) also comprising a mechanical transmission (6) operatively interposed between the gearbox (5) and at least one driving wheel (7) of the self-propelled vehicle.

2. The system according to claim 1, characterised in that it comprises operating and control means (8) which are operatively interposed between the batteries (14) and the electric motor (2), in such a way as to manage the respective electric voltages, keeping them within a suitable range of values.

3. The system according to claim 2, characterised in that the electric voltages are within the input and output limits selected of between 48 and 96V.

4. The system according to claim 2 or 3, characterised in that the operating and control means (8) can be programmed using relative software in a way designed to give the self-propelled vehicle a way of moving which conforms to predetermined acceleration/deceleration characteristics in conformity with graphs of internal combustion engine use.

5. The system according to claim 4, characterised in that the operating and control means (8) can be programmed using relative software in a way designed to give the self-propelled vehicle decelerations corresponding to the action of engine braking in an internal combustion engine.

6. The system according to claim 4, characterised in that the operating and control means (8) can be programmed using relative software in such a way that they translate graphs of internal combustion engine use at the test bench and simulate their operation, thus emulating specific features of existing internal combustion engines.

7. The system according to any of the foregoing claims, characterised in that it comprises sensor means (9) connected to the gearbox (5) for mapping different acceleration/deceleration ramps depending on the gear selected with the gearbox (5).

8. The system according to any of the foregoing claims, characterised in that it comprises accelerometer means (10), operatively interconnected with the operating and control means (8) for regulating the energy supplied by the electric motor (2), the regulation being correlated with traction actions of predetermined intensity exchanged between the driving wheel (7) and the ground.

9. The system according to claim 1, characterised in that the operating and control means (8) are designed to manage the recovery of energy generated by the electric motor (2) itself during drifting and inertial deceleration, activating an exchange circuit designed to recharge the batteries (14) of the self-propelled vehicle when the energy produced is in excess of the energy required to drive the self-propelled vehicle.

10. The system according to any of the foregoing claims, characterised in that the self-propelled vehicle is a road or off-road vehicle.

11. The system according to claim 10, characterised in that the vehicle is a motorcycle.

12. The system according to any of the foregoing claims, characterised in that the electric motor (2) is a multi-pole brushless motor.
